(19) United States
(12) Patent Application Publication
(10) Pub. No.: US 2024/0356339 A1
(43) Pub. Date: Oct. 24, 2024

(54) POWER SYSTEM BALANCE OPTIMIZATION METHOD BASED ON BALANCING UNITS

(71) Applicants: North China Electric Power University, Beijing (CN); Beijing Power Exchange Center Co., Ltd, Beijing (CN)

(72) Inventors: Dunnan LIU, Beijing (CN); Kai XIE, Beijing (CN); Zhu LI, Beijing (CN); Xian ZHANG, Beijing (CN); Heping JIA, Beijing (CN); Xiaofeng XU, Beijing (CN); Hang FAN, Beijing (CN); Yujie XU, Tianjin (CN)

(21) Appl. No.: 18/422,027

(22) Filed: Jan. 25, 2024

(30) Foreign Application Priority Data
Apr. 24, 2023 (CN) 2023104476463

(51) Int. Cl. H02J 3/46; G06Q 10/0631; H02J 3/00; H02J 3/06

(52) U.S. Cl. CPC H02J 3/466; G06Q 10/06312; H02J 3/003; H02J 3/008; H02J 3/06; H02J 2203/10; H02J 2300/24; H02J 2300/28; H02J 2300/40

(57) ABSTRACT

The disclosure provides a power system balance optimization method based on balancing units, including: collecting power generation and consumption information of market subjects in a balancing unit, calculating a output situation of a power generation side when the system operation cost is minimum, and judging whether to carry out a power exchange between units; the balancing unit optimizes and selects an operation strategy according to market environment, and then optimizes and selects the operation strategy according to the market environment; the disclosure carries out hierarchical management through balancing units, and the system balance costs of power generation, regulation, power exchange and fully considers balance cost of power generation, regulation, power exchange and other systems of multiple entities on the power generation side, transmission side and power consumption side.

### TECHNICAL FIELD

The disclosure relates to a technical field of power system control, and in particular to a power system balance optimization method based on balancing units.

### BACKGROUND

At present, with the large-scale access of new energy power generation in China, the strong randomness and strong dispersion at both ends of power generation and power consumption increases the difficulty for the power system to ensure the balance between power generation and power consumption and further increases power system balance cost, and conventional power system balance methods have failed to effectively reduce the balance cost of power system.

In recent years, the global energy shortage and environmental pollution have become increasingly serious. At the same time, with the continuous development of the national economy and the continuous improvement of people's living standards, the demand and requirements for electric energy are getting higher and higher, and at the same time, higher and more requirements are put forward for the smooth operation of the power system.

In the prior art, a balancing unit is usually composed of a plurality of market subjects in the same transmission system control region, such as power producers, electricity suppliers and end users, and all internal members of the same balancing unit must belong to a same dispatching region, so that the balancing unit cannot be formed across regions, thus increasing the balance cost of the power system and bringing greater power grid operation pressure, which cannot guarantee the stable operation of the power grid. Therefore, the invention provides a power system balance optimization method based on the balancing unit to solve the problems existing in the prior art.

### SUMMARY

In view of the above problems, the present disclosure proposes a power system balance optimization method based on balancing units, so as to solve the problem that the existing power system balance optimization method cannot form a balancing unit across regions, which increases the balance cost of the power system and brings greater operating pressure of the power grid.

In order to achieve the purpose of the disclosure, the disclosure is realized by a following technical scheme: a power system balance optimization method based on the balancing units, including following steps:
step 1, collecting power generation information and power consumption information of market subjects in a balancing unit by a balancing responsible subject, where the power consumption information is a power consumption predicted value of the market subjects in the balancing unit;
step 2, after collecting the power generation information and the power consumption information, establishing a balanced operation model of a balancing unit power system by the balancing responsible subject aiming at a minimum total operating cost of a power system, and calculating an output situation of a power generation side when the minimum total operating cost of the power system occurs;
step 3, calculating an internal power balance constraint of the balancing unit according to a calculation result of the output situation of the power generation side, and judging whether to carry out a power exchange between units according to the calculation result;
step 4, when carrying out the power exchange between the units indicated by the judgment result in the step 3, organizing intra-provincial balancing units by provincial power transmission system operators to carry out the power exchange or providing balancing services by provincial balancing service providers to provincial balance regions, so as to realize a balance between power generation and consumption; and
step 5, when the power exchange in the step 4 is uncapable of achieving the balance of power generation and consumption, organizing inter-provincial balancing units by regional power transmission system operators to carry out the power exchange or providing balancing services by regional balancing service providers to regional balance regions, so as to realize the balance between power generation and consumption.

A further improvement lies in that in the step 1, the power generation information includes unit power generation cost, wind and photovoltaic curtailment cost, reserve cost, load adjustment cost and regional balance cost, and the power consumption predicted value adopts a daily average consumption of a power consumption side.

A further improvement lies in that in the step 2, the power generation side of the power system includes thermal power units, wind farms and photovoltaic power stations, where output cost of the thermal power unit is expressed by a quadratic function:

$$\\ min {\sum }_{t = 1}^{T} ( \begin{matrix}{\sum }_{i = 1}^{{N}^{{}_{} a 1}} ( {{a}_{i} ( {P}_{i , t}^{{}_{} a 1} )}^{2} + {b}_{i} {P}_{i , t}^{{}_{} a 1} + {c}_{i} ) + α {\sum }_{j = 1}^{{N}^{{}_{} a 2}} {P}_{j , t}^{{}_{} a 2} + β {\sum }_{k = 1}^{{N}^{{}_{} a 3}} {P}_{k , t}^{{}_{} a 3} + \\ μ {\sum }_{j = 1}^{{N}^{{}_{} b 1}} ( {P}_{j , t}^{{}_{} w , max} - {P}_{j , t}^{{}_{} a 2} ) + v {\sum }_{k = 1}^{{N}^{{}_{} b 2}} ( {P}_{k , t}^{{}_{} pv , max} - {P}_{k , t}^{{}_{} a 3} ) + \\ {C}^{{}_{} +} {τ}_{1} {\sum }_{t = 1}^{T} {L}_{t} + {C}^{{}_{} -} {τ}_{2} {\sum }_{t = 1}^{T} {L}_{t} + {\sum }_{t = 1}^{T} {C}_{t}^{{}_{} DR} {P}_{t}^{{}_{} DR} + \\ {\sum }_{t = 1}^{T} ( {{a}_{i} ( {P}_{t}^{{}_{} +} + {P}_{t}^{{}_{} -} )}^{2} + {b}_{i} ( {P}_{t}^{{}_{} +} + {P}_{t}^{{}_{} -} ) + {c}_{i} ) + {F}_{t}^{{}_{} d}\end{matrix} ) ,$$

where N^{a1} represents a number of thermal power units, P_{i,t}^{a1} represents an actual output of an i-th thermal power unit at t time, aᵢ, bᵢ and cᵢ represent power generation cost coefficients of the i-th thermal power unit, α and β represent respectively unit power generation cost coefficients of wind power and photovoltaic power, N^{a2} and N^{a3} represent respectively numbers of the wind power and the photovoltaic power, P_{j,t}^{a2} and P_{k,t}^{a3} represent k,t respectively actual outputs of a j-th wind farm and a k-th photovoltaic power station at t time, μ and v represent respectively unit wind and photovoltaic curtailment costs of the wind farms and the photovoltaic power stations, N^{b1} and N^{b2} represent respectively numbers of wind power plants and photovoltaic power plants, and P_{j,t}^{w,max} and P_{k,t}^{v,max} represent respectively predicted maximum outputs of the j-th wind farm and a k-th photovoltaic power station at t time. The reserve cost of the power system includes positive reserve cost and negative reserve cost and is provided by the thermal power units, c⁺ and c⁻ represent respectively positive reserve compensation cost and negative reserve compensation cost, τ₁ and τ₂ represent respectively proportions of the positive reserve cost and the negative reserve cost to a regional load Lₜ, Pₜ⁺ and Pₜ⁻ represent respectively actual outputs of the positive reserve cost and the negative reserve cost; the load adjustment cost is generated by demand responses, Pₜ^{DR} represents a response quantity, Cₜ^{DR} represents a load adjustment compensation price, and Fₜ^{d} represents the balancing service cost.

A further improvement lies in that in the step 3, a formula for calculating the internal power balance constraint of the balancing unit is as follows:

$$\\ {\sum }_{t = 1}^{T} ( {P}_{g , t}^{{}_{} a} + {P}_{g , t}^{{}_{} +} + {P}_{g , t}^{{}_{} bal} ) = {\sum }_{t = 1}^{T} ( {L}_{g , t} + {P}_{g , t}^{{}_{} DR} ) ,$$

in the formula, P_{g,t}^{a} represents a total power generation of the power generation side of an unit, P_{g,t}⁺ represents a positive reserve actual output in the unit, P_{g,t}^{bal} represents a total power exchange volume between a balancing unit g and other balancing units, L_{g,t} represents a total system load of the power consumption side and P_{g,t}^{DR} represents the load adjustment.

A further improvement lies in that in the step 3, when judging whether to carry out the power exchange between the units, if the unit power generation is equal to the unit power consumption, the power exchange is not carried out.

A further improvement lies in that in the step 3, when judging whether to carry out the power exchange between the units, if the unit power generation and the unit power consumption are not equal, and a balance demand is generated, the power exchange is carried out.

A further improvement lies in that in the step 4, balancing cost of balancing units include power exchange cost between the intra-provincial balancing units and balancing service cost provided by the provincial balancing service providers, as shown in a following formula:

$$\\ {F}_{1 , t}^{{}_{} d} = m {\sum }_{t = 1}^{T} {C}_{1 , t}^{{}_{} in , bal} {P}_{1 , t}^{{}_{} in , bal} + ( 1 - m ) {\sum }_{t = 1}^{T} {C}_{1 , t}^{{}_{} pro , bal} {P}_{1 , t}^{{}_{} pro , bal} m ∈ \{ 0 , 1 \} ,$$

in the formula, F_{1,t}^{d} represents intra-provincial balancing service cost of the balancing units, C_{1,t}^{in,bal} represents intra-provincial power exchange unit cost in t time, P_{1,t}^{in,bal} represents a total power exchange volume between the intra-provincial balancing units in t time, P_{1,t}^{pro,bal} represents a total power volume provided by the provincial balancing service providers in t time, and C_{1,t}^{pro,bal} represents power unit cost provided by the provincial balancing service providers in t time; when the balancing units choose the provincial power transmission system operators to organize the intra-provincial power exchange, m=1, and when the balancing units choose the provincial balancing service providers to provide the balancing services, m=0.

A further improvement lies in that in the step 5, the unit balancing service cost includes power exchange cost between the inter-provincial balancing units and balancing service cost provided by regional balancing service providers, as shown in a following formula:

$$\\ {F}_{2 , t}^{{}_{} d} = {F}_{1 , t}^{{}_{} d} + n {\sum }_{t = 1}^{T} {C}_{2 , t}^{{}_{} in , bal} {P}_{2 , t}^{{}_{} in , bal} + ( 1 - n ) {\sum }_{t = 1}^{T} {C}_{2 , t}^{{}_{} pro , bal} {P}_{2 , t}^{{}_{} pro , bal} n ∈ \{ 0 , 1 \} ,$$

in the formula, F_{2,t}^{d} represents balancing service cost of inter-provincial balancing units, Fit represents the balancing service cost of the intra-provincial balancing units, C_{2,t}^{in,bal} represents inter-provincial power exchange unit cost in t time, P_{2,t}^{in,bal} represents a total power exchange volume between the inter-provincial balancing units in t time, P_{2,t}^{pro,bal} represents a total power volume provided by the regional balancing service providers in t time, and C_{2,t}^{pro,bal} represents power unit cost provided by the regional balancing service providers in t time; when the balancing units choose the regional power transmission system operators to organize the intra-provincial power exchange, n=1; and when the balancing units choose the regional balancing service providers to provide the balancing services, n=0.

The disclosure has following beneficial effects: according to the disclosure, hierarchical management is carried out through the balancing units, and system balance costs of power generation, regulation, power exchange and the like of multiple entities on the power generation side, the power transmission side and the power consumption side are fully considered. First, the power generation and the power consumption are self-balanced in the region, and if there is an unbalanced part, the power generation and the power consumption are balanced through cross-regional power exchange. By this method, the balancing unit may be formed across regions, thus effectively reducing the power system balance difficulty, further reducing the power system balance cost; at the same time, it is helpful to improve the consumption level of new energy, reduce the operating pressure of power grid and ensure the safe and stable operation of the power grid.

### BRIEF DESCRIPTION OF THE DRAWINGS

In order to more clearly explain embodiments of the present disclosure or the technical scheme in the prior art, the drawings needed to be used in the description of the embodiments or the prior art are briefly introduced below. Obviously, the drawings in the following description are only some embodiments of the present disclosure, and other drawings can be obtained by ordinary people in the field without paying creative labor.

FIG. 1 is a flow diagram of a power system balance optimization method according to Embodiment 1 of the present disclosure.

FIG. 2 is a schematic structural diagram of the power system balance optimization method according to Embodiment 1 of the present disclosure.

FIG. 3 is a schematic diagram showing wind and photovoltaic output prediction curves according to Embodiment 2 of the present disclosure.

FIG. 4 is a schematic diagram of load predictions and load adjustment declaration volume according to Embodiment 2 of the present disclosure.

FIG. 5 is a schematic diagram of operation results of a regional power system in a conventional mode according to Embodiment 2 of the present disclosure.

FIG. 6 is a schematic diagram showing a wind and photovoltaic curtailment situation of the regional power system in the conventional mode according to Embodiment 2 of the present disclosure.

FIG. 7 is a schematic diagram showing a structural division of regional balancing units according to Embodiment 2 of the present disclosure.

FIG. 8 is a schematic diagram showing operation results of the regional power system in a balanced unit operation mode according to Embodiment 2 of the present disclosure.

FIG. 9 is a schematic diagram showing a wind and photovoltaic curtailment situation and a power exchange situation between the regional balancing units in the balancing unit mode according to Embodiment 2 of the present disclosure.

### DETAILED DESCRIPTION OF THE EMBODIMENTS

In the following, the technical scheme in the embodiment of the disclosure will be clearly and completely described with reference to the attached drawings. Obviously, the described embodiment is only a part of the embodiment of the disclosure, but not the whole embodiment. Based on the embodiments in the present disclosure, all other embodiments obtained by ordinary technicians in the field without creative work belong to the scope of protection of the present disclosure.

### Embodiment 1

Market subjects involved in this embodiment include:
(1) A balancing responsible subject: responsible for collecting power generation and consumption information of the market subjects in a corresponding balancing unit, predicting a power generation and consumption situation in the corresponding balancing unit, and realizing an internal balance of the corresponding balancing unit by regulating the power generation and consumption situation in the corresponding balancing unit;
(1) A balancing responsible subject: responsible for collecting power generation and consumption information of the market subjects in a corresponding balancing unit, predicting a power generation and consumption situation in the corresponding balancing unit, and realizing an internal balance of the corresponding balancing unit by regulating the power generation and consumption situation in the corresponding balancing unit;
(2) provincial transmission system operators: responsible for a balance adjustment of provincial balance regions;
(3) regional transmission system operators: responsible for a balance adjustment of regional balance regions;
(4) provincial balancing service providers: responsible for providing balancing services to the provincial balance regions by regulating flexible resources such as energy storage, virtual power plants and quick start-stop units;
(5) regional balancing service providers: responsible for providing balancing services to the regional balance regions by regulating the flexible resources such as energy storage, virtual power plants and quick start-stop units.

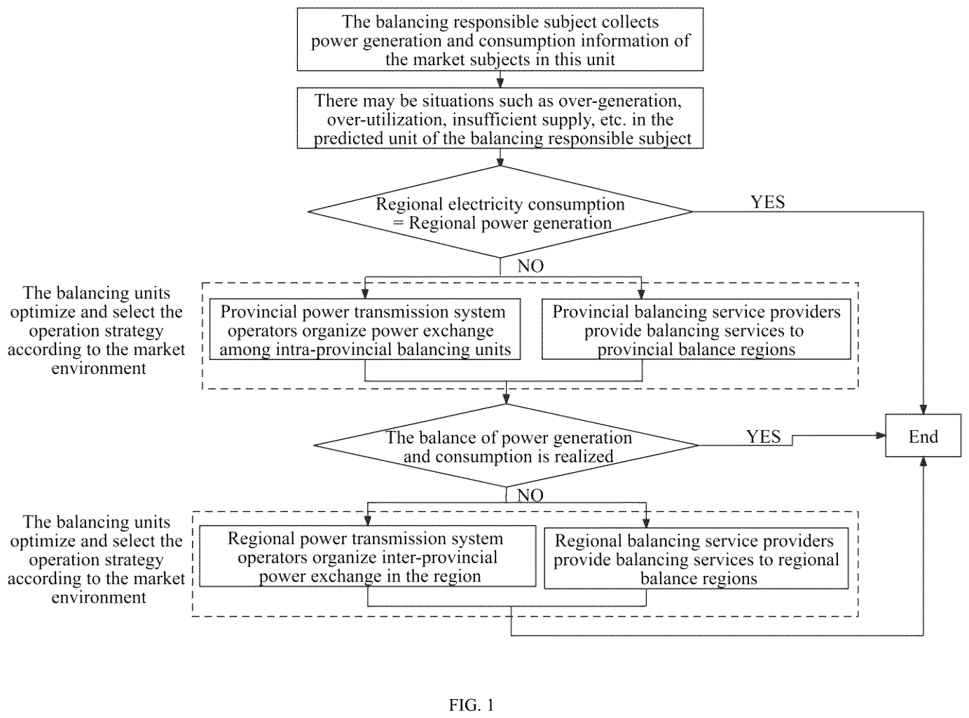

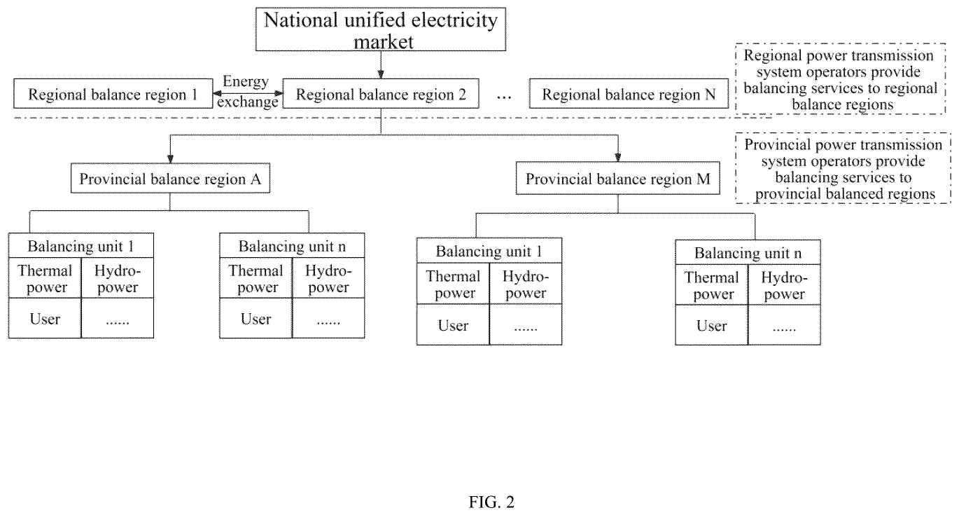

As shown in FIG. 1 and FIG. 2, this embodiment provides a power system balance optimization method based on balancing units, including following steps:

step 1, collecting power generation information and power consumption information of market subjects in a balancing unit by a balancing responsible subject, where the power generation information includes unit power generation cost, wind and photovoltaic curtailment cost, reserve cost, load adjustment cost and regional balance cost, and the power consumption information is a power consumption predicted value of the market subjects in the balancing unit, and the power consumption predicted value adopts a daily average consumption of a power consumption side;

step 2, after collecting the power generation information and the power consumption information, establishing a balanced operation model of a balancing unit power system by the balancing responsible subject aiming at a minimum total operating cost of a power system, and calculating an output situation of a power generation side when the minimum total operating cost of the power system occurs, where the power generation side of the power system includes thermal power units, wind farms and photovoltaic power stations, where output cost of the thermal power unit is expressed by a quadratic function:

$$\\ min {\sum }_{t = 1}^{T} ( \begin{matrix}{\sum }_{i = 1}^{{N}^{{}_{} a 1}} ( {{a}_{i} ( {P}_{i , t}^{{}_{} a 1} )}^{2} + {b}_{i} {P}_{i , t}^{{}_{} a 1} + {c}_{i} ) + α {\sum }_{j = 1}^{{N}^{{}_{} a 2}} {P}_{j , t}^{{}_{} a 2} + β {\sum }_{k = 1}^{{N}^{{}_{} a 3}} {P}_{k , t}^{{}_{} a 3} + \\ μ {\sum }_{j = 1}^{{N}^{{}_{} b 1}} ( {P}_{j , t}^{{}_{} w , max} - {P}_{j , t}^{{}_{} a 2} ) + v {\sum }_{k = 1}^{{N}^{{}_{} b 2}} ( {P}_{k , t}^{{}_{} pv , max} - {P}_{k , t}^{{}_{} a 3} ) + \\ {C}^{{}_{} +} {τ}_{1} {\sum }_{t = 1}^{T} {L}_{t} + {C}^{{}_{} -} {τ}_{2} {\sum }_{t = 1}^{T} {L}_{t} + {\sum }_{t = 1}^{T} {C}_{t}^{{}_{} DR} {P}_{t}^{{}_{} DR} + \\ {\sum }_{t = 1}^{T} ( {{a}_{i} ( {P}_{t}^{{}_{} +} + {P}_{t}^{{}_{} -} )}^{2} + {b}_{i} ( {P}_{t}^{{}_{} +} + {P}_{t}^{{}_{} -} ) + {c}_{i} ) + {F}_{t}^{{}_{} d}\end{matrix} ) ,$$

where N^{a1} represents a number of thermal power units, P_{i,t}^{a1} Pit represents an actual output of an i-th thermal power unit at t time, aᵢ, bᵢ and cᵢ represent power generation cost coefficients of the i-th thermal power unit; the output of new energy has no marginal cost, considering that a certain cost price forms when the power grid purchases electricity from new energy generators, α and β represent respectively unit power generation cost coefficients of wind power and photovoltaic power, N^{a2} and N^{a3} represent respectively numbers of the wind power and the photovoltaic power, P_{j,t}^{a2} and P_{k,t}^{a3} represent respectively actual outputs of a j-th wind farm and a k-th photovoltaic power station at t time; among wind and photovoltaic curtailment costs, μ and v represent respectively unit wind and photovoltaic curtailment costs of the wind farms and the photovoltaic power stations; N^{b1} and N^{b2} represent respectively numbers of wind power plants and photovoltaic power plants, and P_{j,t}^{w,max} and P_{k,t}^{pv,max} represent respectively predicted maximum outputs of the j-th wind farm and a k-th photovoltaic power station at t time. The reserve cost of the power system includes positive reserve cost and negative reserve cost and is provided by the thermal power units, c⁺ and c⁻ represent respectively positive reserve compensation cost and negative reserve compensation cost, τ₁ and τ₂ represent respectively proportions of the positive reserve cost and the negative reserve cost to a regional load Lₜ, Pₜ⁺ and Pₜ⁻ represent respectively actual outputs of the positive reserve cost and the negative reserve cost; according to the calculation of a power generation cost function of thermal power units, for the system with balance control units, a sum of actual reserve output of each balancing unit is the actual reserve output of the system; the load adjustment cost is generated by demand responses, Pₜ^{DR} represents a response quantity, Cₜ^{DR} represents a load adjustment compensation price, and Fₜ^{d} represents the balancing service cost;
Step 3, calculating an internal power balance constraint of the balancing unit according to a calculation result of the output situation of the power generation side, and judging whether to carry out a power exchange between units according to the calculation result. When judging whether to carry out the power exchange between units, if the unit power generation is equal to the unit power consumption, the power exchange is not carried out, and if the unit power generation and the unit power consumption are not equal, the power exchange in the step 4 is carried out. The formula for calculating the internal power balance constraint of the balancing unit is as follows:

$$\\ {\sum }_{t = 1}^{T} ( {P}_{g , t}^{{}_{} a} + {P}_{g , t}^{{}_{} +} + {P}_{g , t}^{{}_{} bal} ) = {\sum }_{t = 1}^{T} ( {L}_{g , t} + {P}_{g , t}^{{}_{} DR} ) ,$$

in the formula, P_{g,t}^{a} represents a total power generation of the power generation side of an unit, P_{g,t}⁺ represents a positive reserve actual output in the unit, P_{g,t}^{bal} represents a total power exchange volume between a balancing unit g and other balancing units, L_{g,t} represents a total system load of the power consumption side and P_{g,t}^{DR} represents the load adjustment.

Step 4, when carrying out the power exchange between the units indicated by the judgment result in the step 3, organizing intra-provincial balancing units by provincial power transmission system operators to carry out the power exchange or providing balancing services by provincial balancing service providers to provincial balance regions, so as to realize a balance between power generation and consumption; balancing cost of balancing units include power exchange cost between the intra-provincial balancing units and balancing service cost provided by the provincial balancing service providers, as shown in a following formula:

$$\\ {F}_{1 , t}^{{}_{} d} = m {\sum }_{t = 1}^{T} {C}_{1 , t}^{{}_{} in , bal} {P}_{1 , t}^{{}_{} in , bal} + ( 1 - m ) {\sum }_{t = 1}^{T} {C}_{1 , t}^{{}_{} pro , bal} {P}_{1 , t}^{{}_{} pro , bal} m ∈ \{ 0 , 1 \} ,$$

in the formula, F_{1,t}^{d} represents intra-provincial balancing service cost of the balancing units, C_{1,t}^{in,bal} represents intra-provincial power exchange unit cost in t time, P_{1,t}^{in,bal} represents a total power exchange volume between the intra-provincial balancing units in t time, P_{1,t}^{pro,bal} represents a total power volume provided by the provincial balancing service providers in t time, and c_{1,t}^{pro,bal} represents power unit cost provided by the provincial balancing service providers in t time; when the balancing units choose the provincial power transmission system operators to organize the intra-provincial power exchange, m=1, and when the balancing units choose the provincial balancing service providers to provide the balancing services, m=0.

Step 5, when the power exchange in the step 4 is uncapable of achieving the balance of power generation and consumption, organizing inter-provincial balancing units by regional power transmission system operators to carry out the power exchange or providing balancing services by regional balancing service providers to regional balance regions, so as to realize the balance between power generation and consumption; the unit balancing service cost includes power exchange cost between the inter-provincial balancing units and balancing service cost provided by regional balancing service providers, as shown in a following formula:

$$\\ {F}_{2 , t}^{{}_{} d} = {F}_{1 , t}^{{}_{} d} + n {\sum }_{t = 1}^{T} {C}_{2 , t}^{{}_{} in , bal} {P}_{2 , t}^{{}_{} in , bal} + ( 1 - n ) {\sum }_{t = 1}^{T} {C}_{2 , t}^{{}_{} pro , bal} {P}_{2 , t}^{{}_{} pro , bal} n ∈ \{ 0 , 1 \} ,$$

in the formula, F_{2,t}^{d} represents balancing service cost of inter-provincial balancing units, F_{1,t}^{d} represents the balancing service cost of the intra-provincial balancing units, C_{2,t}^{in,bal} represents inter-provincial power exchange unit cost in t time, P_{2,t}^{in,bal} represents a total power exchange volume between the inter-provincial balancing units in t time, P_{2,t}^{pro,bal} represents a total power volume provided by the regional balancing service providers in t time, and C_{2,t}^{pro,bal} represents power unit cost provided by the regional balancing service providers in t time; when the balancing units choose the regional power transmission system operators to organize the intra-provincial power exchange, n=1; and when the balancing units choose the regional balancing service providers to provide the balancing services, n=0.

### Embodiment 2

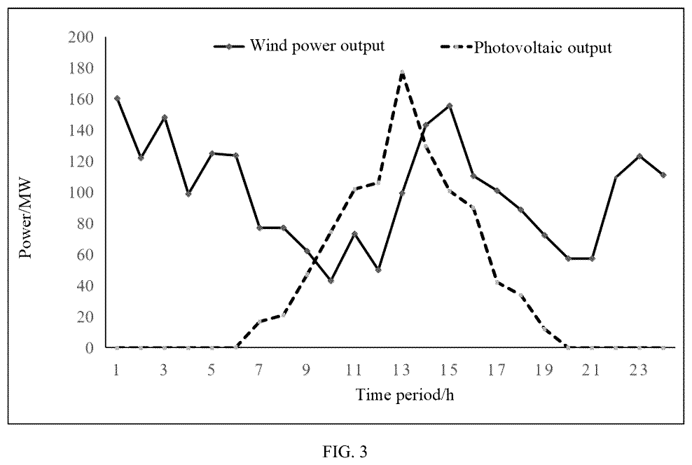

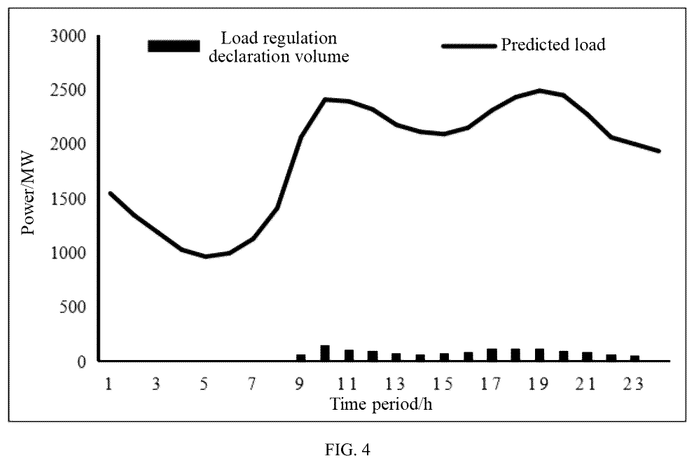

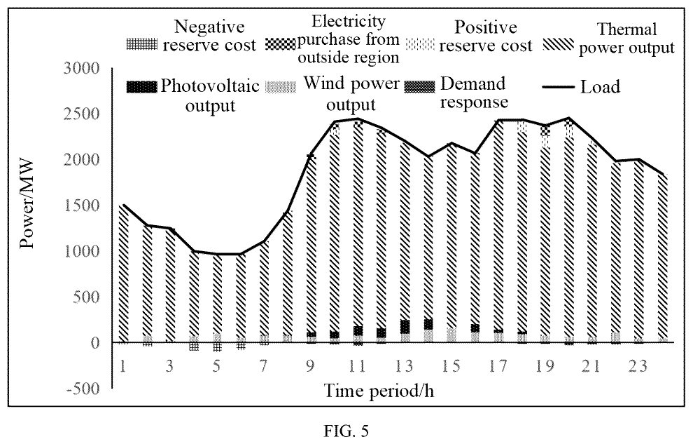

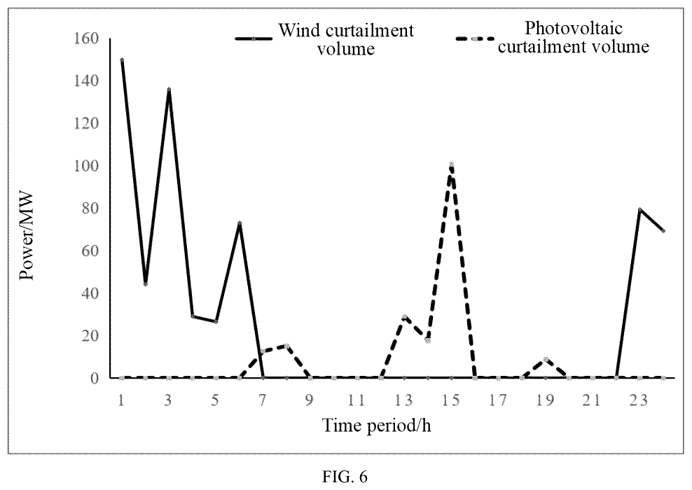

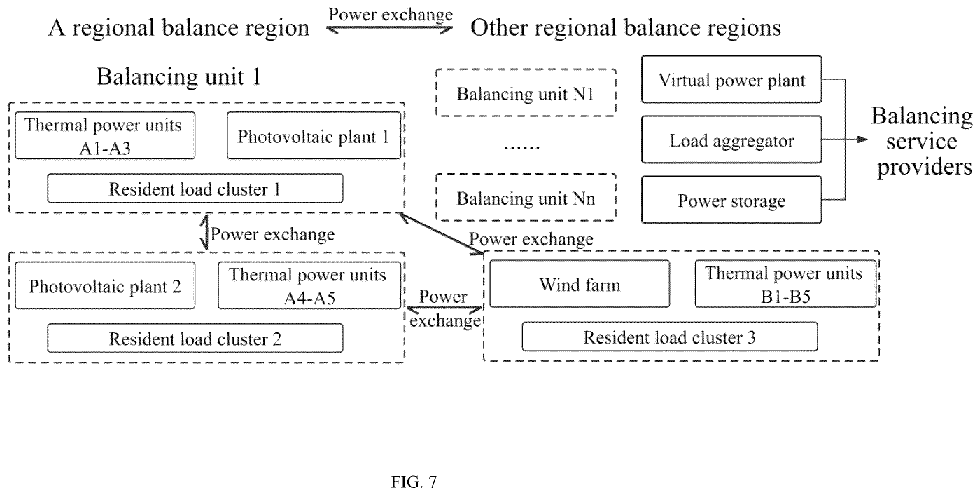

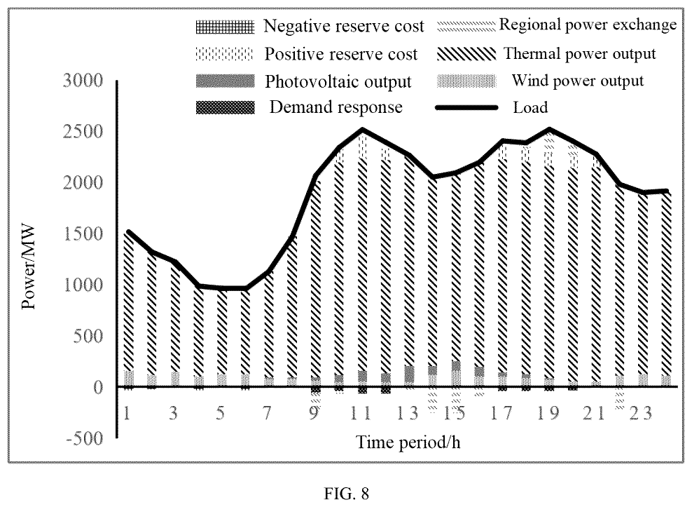

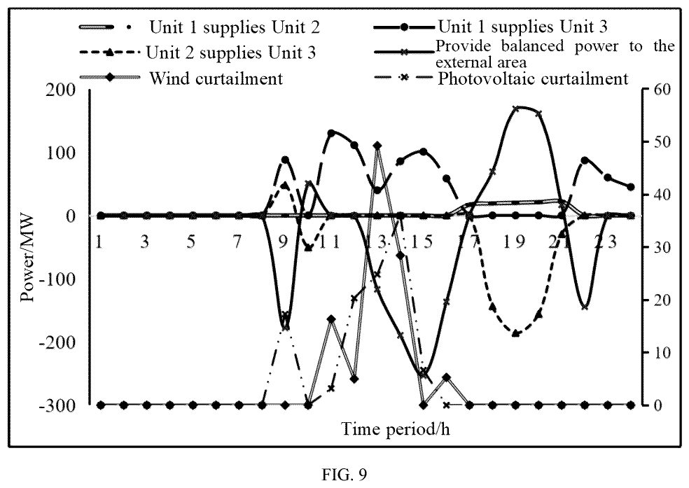

As shown in FIG. 3, FIG. 4, FIG. 5, FIG. 6, FIG. 7, FIG. 8 and FIG. 9, in this embodiment, the regional power system is composed of five 350 MW thermal power units, five 150 MW thermal power units, one 200 MW wind power plant, two 100 MW photovoltaic power plants and a large-scale residential load cluster, and the positive and negative reserve requirements of the system are set at 5% and 3% of the regional load forecast respectively.

The unit power generation cost coefficients α and β of wind power and respectively photovoltaic power plants are 200 yuan/MWh and 300 yuan/MWh; the unit wind and photovoltaic curtailment cost μ and v are both 100 yuan/MWh; and the positive reserve compensation cost c⁺ and the negative reserve compensation cost c⁻ of the system are respectively 10 yuan/MWh and 5 yuan/MWh.

Equipment parameters are shown in Table 1, time divisions and time-of-use electricity prices are shown in Table 2, predicted output curves of the wind farms and the photovoltaic power stations are shown in FIG. 3, the load prediction and load adjustment declaration volume are shown in FIG. 4, and the actual load fluctuates randomly in the range of ±5%.

TABLE 1
Thermal power unit parameters

| | | Upper and | | | |
|---|---|---|---|---|---|
| | | lower limits | Unit power generation | | |
| | Unit | of active | cost coefficient | | |
| Unit | capacity/MW | output/MW | a | b | c |
| A1-A5 | 350 | 320/140 | 0.000433 | 0.195 | 40.62 |
| B1-B5 | 150 | 140/70 | 0.001021 | −0.065 | 84.0162 |

TABLE 2
Time-of-use electricity prices (yuan/MWh)

| | | Real time | Balancing | Load adjustment |
|---|---|---|---|---|
| | Time period | electricity | service | compensation |
| Time period | state | price | price | price |
| 01:00-09:00 | Valley time | 553 | 50 | — |
| | period | | | |
| 09:00-12:00 | Peak time | 866 | 350 | 400 |
| | period | | | |
| 12:00-16:00 | Flat time | 703 | 150 | 300 |
| | period | | | |
| 16:00-21:00 | Peak time | 866 | 350 | 400 |
| | period | | | |
| 21:00-23:00 | Flat time | 703 | 150 | 300 |
| | period | | | |
| 23:00-24:00 | Valley time | 553 | 50 | — |
| | period | | | |

24 hours are taken as a system operation cycle and 1 hour as a period, the model is solved by Gurobi solver with the goal of minimizing the operating cost. When there is no balancing unit in the system, the results of regional balance optimization are shown in FIG. 5, and the wind and photovoltaic curtailment situation is shown in FIG. 6.

During a period from 01:00 to 09:00, the actual power generation of thermal power is less than the planned power generation, and the negative reserve output makes up for the load fluctuation. During this period, the load level is low, and the photovoltaic output capacity is not good, so the wind power output is capable of complementing it. However, due to the low levelized cost of energy of thermal power, the system is balanced by the thermal power output, and the system has wind curtailment. During a period from 09:00 to 16:00, the load peaks first and then levels off, and the photovoltaic energy generates large amounts of electricity and wind power fluctuate in a certain range. At the same time, thermal power units including reserve resources need to be put into the system for balance adjustment. Among them, during a period from 10:00 to 11:00, the load is high, the power generation resources are insufficient, and the reserve power is obviously contributed, and it is necessary to purchase electricity from outside regions to achieve balance; However, during a period from 13:00 to 16:00, the load demand is reduced, and there is more photovoltaic power generation, so there is photovoltaic curtailment. During a period from 17:00 to 24:00, there is widespread load regulation, and the load gradually drops from peak to trough, the photovoltaic output decreases, and the wind power continues to output. During a peak period from 17:00 to 21:00, there is a shortage of regional power generation, and the volume of wind and photovoltaic curtailment of the system is small. Thermal power still participates in regulation with large power and at the same time, provides positive reserve power and purchases electricity from outside. During a period of 21:00-24:00, the utilization of reserve resources is reduced, and there is wind curtailment when the load is reduced. To sum up, in the conventional mode, there are some problems in the system, such as wind and photovoltaic curtailment in low valley period, photovoltaic curtailment in normal period and insufficient power generation in peak period.

The regional system balance mode based on the balancing units is shown in FIG. 7, the resources in the region are divided into three balancing units, with positive reserve resources provided by thermal power units A1-A3 and negative reserve resources evenly distributed in three load clusters. The regional balance is optimized on the basis of the balance between power generation and consumption in the balancing units, and the balance priority of the balancing units is unit 1 before unit 2 and unit 3. The optimization results are shown in FIG. 8 and FIG. 9.

By comparing FIG. 5 and FIG. 8, the reserve output and the regional power exchange are increased, the balance adjustment is more refined, and the proportion of wind and photovoltaic output is higher. By comparing FIG. 6 and FIG. 9, it may be found that the wind and photovoltaic curtailment are obviously alleviated, mainly at 9:00-16:00, and the maximum wind and photovoltaic curtailment is about 50 MW, which is about one third of that in the conventional mode. In order to achieve self-balance, the power exchange of balancing units in the region generally exists in normal peak periods. Balancing unit 1 is rich in power generation resources, mainly providing power to other units and the power exchange frequency between balancing units 2 and 3 and between balancing units 1 and 3 is basically the same. When the balancing service power between regions is frequent, the frequency of power exchange between units in the region is also high. During a period from 18:00 to 21:00, the regional power generation resources are insufficient, and the balancing unit 3 gives priority to providing power to the balancing unit 2 when the supply of the balancing unit 3 is less than the demand, so as to realize the balancing of the balancing unit 2, and at the same time, the region obtains the balancing services provided by other regional units. Through the above analysis, it may be found that in the balanced unit mode, the power exchange between balanced units is more frequent in normal periods, and the power exchange between balanced units and cross-regional balanced services make the power regulation more accurate.

Comparisons of operating costs of power system under different operating modes is shown in Table 3 below:

TABLE 3
Comparison of operating costs of power system under different operating modes

| | | Conventional mode | | Balancing unit mode | |
|---|---|---|---|---|---|
| Cost/yuan | | Cost | Proportion | Cost | Proportion |
| Power generation cost | Thermal power cost | 24720 | 1.96% | 39413 | 3.47% |
| | Wind power cost | 356600 | 28.31% | 457012 | 40.29% |
| | Photovoltaic cost | 230937 | 18.33% | 253556 | 22.35% |
| Wind and photovoltaic | Wind curtailment cost | 60629 | 4.81% | 10423 | 0.92% |
| curtailment cost | Photovoltaic | 18362 | 1.46% | 10822 | 0.95% |
| | curtailment cost | | | | |

| | | | | |
|---|---|---|---|---|
| Reserve cost | 194220 | 15.42% | 194376 | 17.14% |
| Load adjustment cost | 39413 | 3.13% | 144971 | 12.78% |
| Balance cost | 334817 | 26.58% | 23684 | 2.09% |

| | | |
|---|---|---|
| System operation total cost | 1259698 | 1134257 |

As may be seen from Table 3, the operating cost of the power system under the balanced unit operation mode is lower. In the balanced unit mode, the cost of all kinds of power generation is increased, and the wind and photovoltaic curtailment cost is reduced. The reserve cost in the two modes is similar, and the load adjustment cost in the balanced unit mode is much higher than that in the conventional mode, but the balance cost is much lower than that in the conventional mode. From the perspective of cost proportion, the main cost in both modes comes from the power generation. In the conventional mode, the balance cost is greater than the reserve cost, and both of them are significantly greater than the load adjustment cost. In the balanced unit mode, the reserve cost is greater than the load adjustment cost, and both are significantly greater than the balance cost, which shows a opposite situation. Therefore, it may be seen that the balancing unit mode may play the role of regulating thermal power units and adjustable loads because of its hierarchical regulation characteristics. Although it increases the regulation cost, it also balances the fluctuation of wind power and photovoltaic output in regional power grids more finely, thus significantly reducing the balance cost compared with the conventional mode and helping the system to achieve balance more economically.

The above is only the preferred embodiment of the disclosure, and it is not used to limit the disclosure. Any modification, equivalent substitution, improvement, etc. made within the spirit and principle of the disclosure should be included in the protection scope of the disclosure.

1. A power system balance optimization method based on balancing units, comprising following steps:
step 1, collecting power generation information and power consumption information of market subjects in a balancing unit by a balancing responsible subject, wherein the power consumption information is a power consumption predicted value of the market subjects in the balancing unit;
step 2, after collecting the power generation information and the power consumption information, establishing a balanced operation model of a balancing unit power system by the balancing responsible subject aiming at a minimum total operating cost of a power system, and calculating an output situation of a power generation side when the minimum total operating cost of the power system occurs, wherein the power generation side of the power system comprises thermal power units, wind farms and photovoltaic power stations, wherein output cost of the thermal power units is expressed by a quadratic function:
$$\\ min {\sum }_{t = 1}^{T} ( \begin{matrix}{\sum }_{i = 1}^{{N}^{{}_{} a 1}} ( {{a}_{i} ( {P}_{i , t}^{{}_{} a 1} )}^{2} + {b}_{i} {P}_{i , t}^{{}_{} a 1} + {c}_{i} ) + α {\sum }_{j = 1}^{{N}^{{}_{} a 2}} {P}_{j , t}^{{}_{} a 2} + β {\sum }_{k = 1}^{{N}^{{}_{} a 3}} {P}_{k , t}^{{}_{} a 3} + \\ μ {\sum }_{j = 1}^{{N}^{{}_{} b 1}} ( {P}_{j , t}^{{}_{} w , max} - {P}_{j , t}^{{}_{} a 2} ) + v {\sum }_{k = 1}^{{N}^{{}_{} b 2}} ( {P}_{k , t}^{{}_{} pv , max} - {P}_{k , t}^{{}_{} a 3} ) + \\ {C}^{{}_{} +} {τ}_{1} {\sum }_{t = 1}^{T} {L}_{t} + {C}^{{}_{} -} {τ}_{2} {\sum }_{t = 1}^{T} {L}_{t} + {\sum }_{t = 1}^{T} {C}_{t}^{{}_{} DR} {P}_{t}^{{}_{} DR} + \\ {\sum }_{t = 1}^{T} ( {{a}_{i} ( {P}_{t}^{{}_{} +} + {P}_{t}^{{}_{} -} )}^{2} + {b}_{i} ( {P}_{t}^{{}_{} +} + {P}_{t}^{{}_{} -} ) + {c}_{i} ) + {F}_{t}^{{}_{} d}\end{matrix} ) ,$$
wherein N^{a1} represents a number of thermal power units, P_{i,t}^{a1} represents an actual output of an i-th thermal power unit at t time, aᵢ, bᵢ and cᵢ represent power generation cost coefficients of the i-th thermal power unit, α and β represent respectively unit power generation cost coefficients of wind power and photovoltaic power, N^{a2} and N^{a3} represent respectively numbers of the wind power and the photovoltaic power, P_{j,t}^{a2} and P_{k,t}^{a3} represent respectively actual outputs of a j-th wind farm and a k-th photovoltaic power station at t time, μ and v represent respectively unit wind and photovoltaic curtailment costs of the wind farms and the photovoltaic power stations, N^{b1} and N^{b2} represent respectively numbers of wind power plants and photovoltaic power plants, and P_{j,t}^{w,max} and P_{k,t}^{pv,max} represent respectively predicted maximum outputs of the j-th wind farm and a k-th photovoltaic power station at t time, reserve cost of the power system comprises positive reserve cost and negative reserve cost and is provided by the thermal power units, c⁺ and c⁻ represent respectively positive reserve compensation cost and negative reserve compensation cost, τ₁ and τ₂ represent respectively proportions of the positive reserve cost and the negative reserve cost to a regional load Lₜ, Pₜ⁺ and Pₜ⁻ represent respectively actual outputs of the positive reserve cost and the negative reserve cost; the load adjustment cost is generated by demand responses, Pₜ^{DR} represents a response quantity, Cₜ^{DR} represents a load adjustment compensation price, and Fₜ^{d} represents the balancing service cost;
step 3, calculating an internal power balance constraint of the balancing unit according to a calculation result of the output situation of the power generation side, and judging whether to carry out a power exchange between units according to the calculation result;
step 4, when carrying out the power exchange between the units indicated by the judgment result in the step 3, organizing intra-provincial balancing units by provincial power transmission system operators to carry out the power exchange or providing balancing services including regulating energy storage, virtual power plants and start-stop units by provincial balancing service providers to provincial balance regions, so as to realize a balance between power generation and consumption; balancing cost of balancing units comprise power exchange cost between the intra-provincial balancing units and balancing service cost provided by the provincial balancing service providers, as shown in a following formula:
$$\\ {F}_{1 , t}^{{}_{} d} = m {\sum }_{t = 1}^{T} {C}_{1 , t}^{{}_{} in , bal} {P}_{1 , t}^{{}_{} in , bal} + ( 1 - m ) {\sum }_{t = 1}^{T} {C}_{1 , t}^{{}_{} pro , bal} {P}_{1 , t}^{{}_{} pro , bal} m ∈ \{ 0 , 1 \} ,$$
in the formula, F_{1,t}^{d} represents intra-provincial balancing service cost of the balancing units, C_{1,t}^{in,bal} represents intra-provincial power exchange unit cost in t time, P_{1,t}^{in,bal} represents a total power exchange volume between the intra-provincial balancing units in t time, P_{1,t}^{pro,bal} represents a total power volume provided by the provincial balancing service providers in t time, and C_{1,t}^{pro,bal} represents power unit cost provided by the provincial balancing service providers in t time; when the balancing units choose the provincial power transmission system operators to organize the intra-provincial power exchange, m=1, and when the balancing units choose the provincial balancing service providers to provide the balancing services, m=0; and
step 5, when the power exchange in the step 4 is uncapable of achieving the balance of power generation and consumption, organizing inter-provincial balancing units by regional power transmission system operators to carry out the power exchange or providing balancing services including regulating energy storage, virtual power plants and start-stop units by regional balancing service providers to regional balance regions, so as to realize the balance between power generation and consumption; the unit balancing service cost comprises power exchange cost between the inter-provincial balancing units and balancing service cost provided by regional balancing service providers, as shown in a following formula:
$$\\ {F}_{2 , t}^{{}_{} d} = {F}_{1 , t}^{{}_{} d} + n {\sum }_{t = 1}^{T} {C}_{2 , t}^{{}_{} in , bal} {P}_{2 , t}^{{}_{} in , bal} + ( 1 - n ) {\sum }_{t = 1}^{T} {C}_{2 , t}^{{}_{} pro , bal} {P}_{2 , t}^{{}_{} pro , bal} n ∈ \{ 0 , 1 \} ,$$
in the formula, F_{2,t}^{d} represents balancing service cost of inter-provincial balancing units, F_{1,t}^{d} represents the balancing service cost of the intra-provincial balancing units, C_{2,t}^{in,bal} represents inter-provincial power exchange unit cost in t time, P_{2,t}^{in,bal} represents a total power exchange volume between the inter-provincial balancing units in t time, P_{2,t}^{pro,bal} represents a total power volume provided by the regional balancing service providers in t time, and C_{2,t}^{pro,bal} represents power unit cost provided by the regional balancing service providers in t time; when the balancing units choose the regional power transmission system operators to organize the intra-provincial power exchange, n=1; and when the balancing units choose the regional balancing service providers to provide the balancing services, n=0.

2. The power system balance optimization method based on the balancing units according to claim 1, wherein in the step 1, the power generation information comprises unit power generation cost, wind and photovoltaic curtailment cost, reserve cost, load adjustment cost and regional balance cost, and the power consumption predicted value adopts a daily average consumption of a power consumption side.

3. The power system balance optimization method based on the balancing units according to claim 1, wherein in the step 3, a formula for calculating the internal power balance constraint of the balancing unit is as follows:
$$\\ {\sum }_{t = 1}^{T} ( {P}_{g , t}^{{}_{} a} + {P}_{g , t}^{{}_{} +} + {P}_{g , t}^{{}_{} bal} ) = {\sum }_{t = 1}^{T} ( {L}_{g , t} + {P}_{g , t}^{{}_{} DR} ) ,$$
in the formula, P_{g,t}^{a} represents a total power generation of the power generation side of an unit, P_{g,t}⁺ represents a positive reserve actual output in the unit, P_{g,t}^{bal} represents a total power exchange volume between a balancing unit g and other balancing units, L_{g,t} represents a total system load of the power consumption side and P_{g,t}^{DR} represents the load adjustment.

4. The power system balance optimization method based on the balancing units according to claim 1, wherein in the step 3, when judging whether to carry out the power exchange between the units, if the unit power generation is equal to the unit power consumption, the power exchange is not carried out.

5. The power system balance optimization method based on the balancing units according to claim 1, wherein in the step 3, when judging whether to carry out the power exchange between the units, if the unit power generation and the unit power consumption are not equal, and a balance demand is generated, the power exchange is carried out.
